(19) United States
(12) Patent Application Publication
(10) Pub. No.: US 2016/0231260 A1
(43) Pub. Date: Aug. 11, 2016

(54) SAMPLE HOLDER ADAPTED TO PARALLEL SAMPLE ISOTHERMAL CALORIMETRY

(71) Applicant: SYMCEL SVERIGE AB, Kista (SE)

(72) Inventors: Magnus JANSSON, Bromma (SE); Christer WALLIN, Spånga (SE)

(73) Assignee: SYMCEL SVERIGE AB, Kista (SE)

(21) Appl. No.: 15/021,905

(22) PCT Filed: Aug. 20, 2014
(86) PCT No.: PCT/SE2014/050952

§ 371 Date: Mar. 14, 2016

(30) Foreign Application Priority Data
Sep. 30, 2013 (SE) 1351140-7

(51) Int. Cl. G01N 25/48; B01L 3/00; B01L 9/06

(52) U.S. Cl. CPC G01N 25/486; B01L 9/06; B01L 3/5082; B01L 2300/12; B01L 2300/0829; B01L 2300/0832; B01L 2300/0887; B01L 2200/02

(57) ABSTRACT

A sample holder adapted to parallel sample isothermal calorimetry performed using microtiter plate layout and horizontal sample loading with a mechanism where the individual sample vials can be individually vertically variable. The sample holder includes a sample holder plate and a surrounding frame, where the sample holder plate is constructed of a multi material low mass multi-layer sandwich and the surrounding frame is constructed of a low mass material with high heat conductivity.

### FIELD OF INVENTION

The present invention relates to a sample holder adapted to parallel sample isothermal calorimetry performed using microtiter plate layout and horizontal sample loading with a mechanism where individual sample vials can be individually vertically variable. The invention also relates to a sample vial adapted to be held by the inventive sample holder.

### DESCRIPTION OF BACKGROUND ART

Patent publication WO 2007/139498 discloses an example of parallel sample isothermal calorimetry performed using microtiter plate layout and horizontal sample loading where the individual samples can be individually vertically variable.

Sample insertion by horizontal movement allows contact between the thermostatic regulated inner surfaces of the pre heating/equilibrium chamber via the vial bottom to allow heat transfer to occur. Upon transferring the vials to the measurement position the vials are positioned to heat flow sensitive sensors.

### SUMMARY OF THE PRESENT INVENTION

### Problems

The individual sample vials in a multi-channel plate format isothermal calorimeter device, based on horizontal sample loading, must be able to move in the vertical plane. The individual vials must be removable for sample loading, must be able to adjust to possible differences in the supporting structure upon temperature equilibrium as well as individual vertical movement to maximize contact to the sensor upon measurement.

The plate arranging the sample vials must be lightweight to allow fast temperature equilibrium yet rigid and minimizing physical contact surfaces between sample vial and plate structure to minimize heat transfer between samples.

### Solution

From the standpoint of a sample holder adapted to parallel sample isothermal calorimetry and with the purpose of solving one or more of the above mentioned problems, the present invention teaches that the sample holder comprises a sample holder plate and a surrounding frame, that the sample holder plate is constructed of a multi material low mass multi-layer sandwich with low heat conductivity, and that the surrounding frame is constructed of a low mass material with high heat conductivity.

It is proposed that the sample holder plate is constructed of at least two layers of low heat conducting plastic compound, and the surrounding frame is constructed of aluminum.

The invention teaches that the sample holder is adapted to hold a sample vial by means of at least three pegs positioned in the sample holder plate and pointing into a vial opening in the sample holding plate, each peg forming a contact surface with the sample vial, and that the distance between the pegs allows a sample vial to move freely between the pegs.

The sample holder may be adapted to follow the size restrictions imposed by using a standardized microtiter plate layout, such as described in Standard; ANSI/SBS 1-2004

The present invention also relates to a sample vial adapted to rest in an inventive sample holder. It is proposed that the sample vial is adapted to rest upon the pegs by means of a collar on the sample vial.

### Advantages

The advantages of a sample holder and a sample vial according to the present invention is that the low mass material with high heat conductivity of the surrounding frame allows fast heat transfers when in contact with the temperature equilibrium chamber floor of a calorimeter, and the low heat conducting plastic compound of the sample holder plate allows for a low degree of heat transfer between sample vials.

Other advantages are that the combination of sample holder and sample vials allow vertical movement and contact between sample vials and the sensor or heat chamber of a calorimeter to be individually adjustable as well as minimizing the construction mass and reducing heat flow cross contamination between sample vials.

### BRIEF DESCRIPTION OF THE DRAWINGS

A sample holder and a vial according to the present invention will now be described in detail with reference to the accompanying drawings, in which:

FIG. 1 is a perspective view of an inventive sample holder,

FIG. 2 is a schematic and simplified illustration of a vial opening in the sample holder, and

FIG. 3 is a side view of a sample vial.

### DESCRIPTION OF EMBODIMENTS AS PRESENTLY PREFERRED

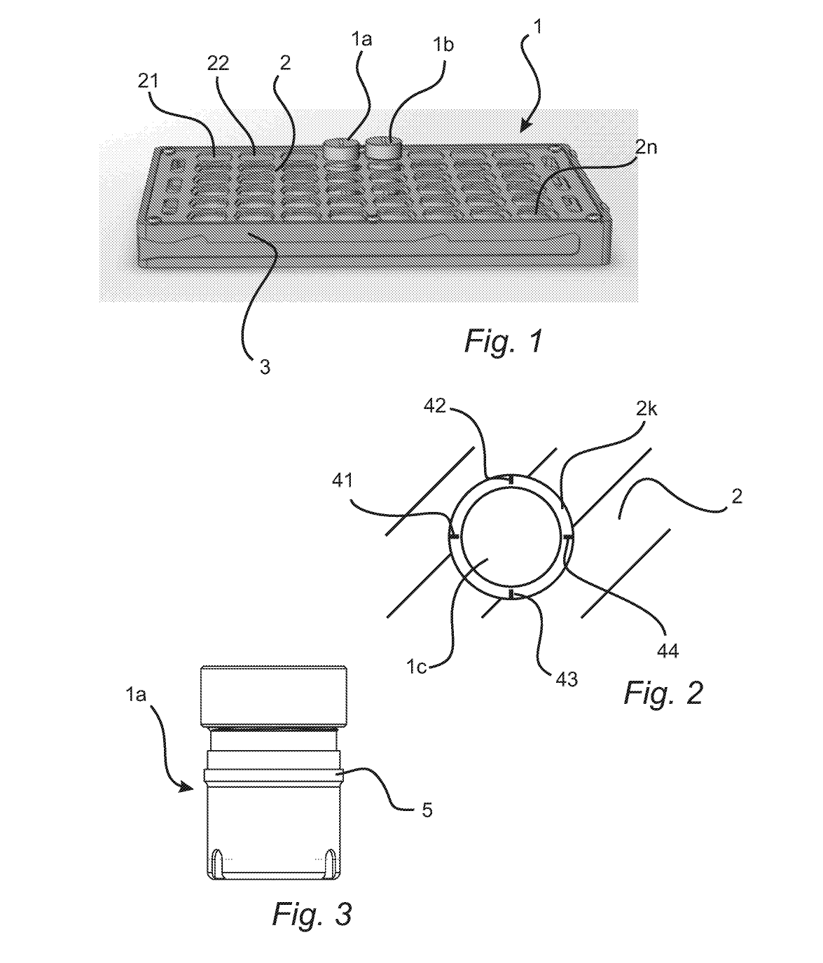

The present invention will now be described with reference to FIG. 1 showing a sample holder 1 adapted to parallel sample isothermal calorimetry performed using microtiter plate layout and horizontal sample loading with a mechanism where the individual sample vials 1a, 1b can be individually vertically variable.

The sample holder comprises a sample holder plate 2 and a surrounding frame 3. The sample holder plate 2 has openings 21, 21, . . . , 2n adapted to hold the used sample vials 1a, 1b. The sample holder plate 2 is constructed of a multi material low mass multi-layer sandwich with low heat conductivity, and that the surrounding frame 3 is constructed of a low mass material with high heat conductivity.

It is proposed that the sample holder plate 2 may be constructed of at least two layers of low heat conducting plastic compound and that the surrounding frame may 3 be constructed of aluminum.

FIG. 2 is a schematic figure showing one of the vial openings 2k adapted to hold a vial 1c. With the purpose of providing a sample holder 1 where the sample vial 1c is free to move vertically it is proposed that the sample holder 1 is adapted to hold a sample vial 1c by means of at least three pegs, where four pegs 41, 42, 43, 44, are used in the exemplifying embodiment shown in the figure. The pegs 41, 42, 43, 44 positioned in the sample holder plate 2 and pointing into the vial opening 2k in the sample holding plate 2, each peg 41, 42, 43, 44 forming a contact surface with the sample vial 4. The extension of the pegs 41, 42, 43, 44 into the opening 11 is adapted to form a distance between the pegs 41, 42, 43, 44 that allows a sample vial 3 to move freely between the pegs 41, 42, 43, 44 so that the vials can be individually vertically variable.

FIG. 3 shows an inventive sample vial 1a adapted to rest in an inventive sample holder 1. In order to prevent the vial 1a from falling out of the sample holder 1 it is proposed that the sample vial 1a is adapted to rest upon the pegs 41, 42, 43, 44 by means of a collar 5 on the sample vial 1a.

The sample holder 1 may be adapted to follow the size restrictions imposed by using a standardized microtiter plate layout, such as described in Standard; ANSI/SBS 1-2004

It will be understood that the invention is not restricted to the aforedescribed and illustrated exemplifying embodiments thereof and that modifications can be made within the scope of the invention as defined by the accompanying Claims.

1. A sample holder adapted to parallel sample Isothermal calorimetry performed using microtiter plate layout and horizontal sample loading with a mechanism where the individual sample vials can be individually vertically variable, the sample holder comprising:
a sample holder plate; and
a surrounding frame,
wherein the sample holder plate is constructed of a multi material low mass multi-layer sandwich with low heat conductivity, and wherein the surrounding frame is constructed of a low mass material with high heat conductivity.

2. The sample holder according to claim 1, wherein the sample holder plate is constructed of at least two layers of low heat conducting plastic compound.

3. The sample holder according to claim 1, wherein the surrounding frame is constructed of aluminum.

4. The sample holder according to claim 1, wherein the sample holder is adapted to hold a sample vial by means of at least three pegs positioned in the sample holder plate and pointing into a vial opening in the sample holding plate, each peg forming a contact surface with the sample vial, and wherein the distance between the pegs allows a sample vial to move freely between the pegs.

5. The sample holder according to claim 1, wherein the sample holder is adapted to follow the size restrictions imposed by using a standardized microtiter plate layout.

6. A sample vial adapted to rest in the sample holder according to claim 4, wherein the sample vial is adapted to rest upon the pegs by means of a collar on the sample vial.

7. The sample holder according to claim 2, wherein the surrounding frame is constructed of aluminum.

8. The sample holder according to claim 2, wherein the sample holder is adapted to hold a sample vial by means of at least three pegs positioned in the sample holder plate and pointing into a vial opening in the sample holding plate, each peg forming a contact surface with the sample vial, and that the distance between the pegs allows a sample vial to move freely between the pegs.

9. The sample holder according to claim 3, wherein the sample holder is adapted to hold a sample vial by means of at least three pegs positioned in the sample holder plate and pointing into a vial opening in the sample holding plate, each peg forming a contact surface with the sample vial, and that the distance between the pegs allows a sample vial to move freely between the pegs.

10. The sample holder according to claim 2, wherein the sample holder is adapted to follow the size restrictions imposed by using a standardized microtiter plate layout.

11. The sample holder according to claim 3, wherein the sample holder is adapted to follow the size restrictions imposed by using a standardized microtiter plate layout.

12. The sample holder according to claim 4, wherein the sample holder is adapted to follow the size restrictions imposed by using a standardized microtiter plate layout.

13. The sample holder according to claim 1, wherein the sample holder is adapted to follow the size restrictions imposed by using a standardized microtiter plate layout, as described in Standard; ANSI/SBS 1-2004.

14. The sample holder according to claim 2, wherein the sample holder is adapted to follow the size restrictions imposed by using a standardized microtiter plate layout, as described in Standard; ANSI/SBS 1-2004.

15. The sample holder according to claim 3, wherein the sample holder is adapted to follow the size restrictions imposed by using a standardized microtiter plate layout, as described in Standard; ANSI/SBS 1-2004.

16. The sample holder according to claim 4, wherein the sample holder is adapted to follow the size restrictions imposed by using a standardized microtiter plate layout, as described in Standard; ANSI/SBS 1-2004.
